(19) United States
(12) Patent Application Publication
(10) Pub. No.: US 2010/0002435 A1
(43) Pub. Date: Jan. 7, 2010

(54) LED LIGHT WITH A DIFFRACTING LENS

(75) Inventor: Randal Rash, Fort Lauderdale, FL (US)

Correspondence Address: DARBY & DARBY P.C., P.O. BOX 770, Church Street Station, New York, NY, 10008-0770, US

(73) Assignee: Underwater Lights USA, LLC

(21) Appl. No.: 12/494,589

(22) Filed: Jun. 30, 2009

Related U.S. Application Data
(60) Provisional application No. 61/077,200, filed on Jul. 1, 2008.

(51) Int. Cl. F21V 1/00

(52) U.S. Cl. 362/235

(57) ABSTRACT

The present invention is an underwater light for watertight installation under the waterline of a vessel, for example, within a thru-hull of the vessel, comprising a domed or plano convex diverging lens capable of diverging the light broadly through the water. In a preferred embodiment, the underwater light employs an LED array light source.

### PRIORITY CLAIM

This application claims priority to provisional application 61/077,200 filed on Jul. 1, 2008. This application is related to, cross references and incorporates by reference the subject matter of provisional patent application Ser. No. 61/028,293 filed on Feb. 13, 2008 and provisional patent application Ser. No. 60/844,777 filed on Sep. 15, 2006 which was converted as patent application Ser. No. 11/901,367 filed on Sep. 17, 2007 and provisional patent application Ser. No. 60/715,625 filed on Sep. 9, 20005 which was converted as patent application Ser. No. 11/517,081 filed on Sep. 7, 2006.

### BACKGROUND OF THE INVENTION

Underwater view ports have been used on ships, boats or other watercraft for decorative and safety purposes as well as to aid exploration of the surrounding water. Similarly, lighting has been applied to these same types of watercraft to improve visibility during the dark hours or during periods of overcast or cloudy conditions. Lights have been applied so as to illuminate the sides of the watercraft in order to better visualize the watercraft from a distance, to further enhance the appearance of the watercraft, and to illuminate the surrounding water area. Lights have been mounted in various locations on the deck or hull of the watercraft to accomplish this purpose.

Conventional view ports use a frame to mount a substantially transparent window to the hull. Smaller view ports have used a single piece thru-hull having a mechanically or chemically fastened window inside the thru-hull fitting.

Thru-hull mounted lights are often in the form of light strips composed of a string of high intensity light bulbs contained within a housing or a plurality of individual lights within a housing applied externally along the perimeter of the hull and oriented to shine downwards along the hull. Various applications of the housings and light shields are used to redirect the light rays from the light source downward along the surface of the hull (including the ability to adjust the housings in order to project beams along a desired path). Although such configurations provide substantial illumination of the hull sides, they are not waterproof or watertight and therefore are placed substantially higher than the waterline. Therefore, little to no illumination of the surrounding water area is provided as the light intensity fades considerably from the light source as it reaches the waterline. Furthermore, because the light rays are directed downward along the surface of the hull, illumination is restricted primarily to the line of the watercraft and therefore does not deviate outward into the surrounding water and may be easily obstructed by other accessories attached to the hull of the watercraft that are closer to the waterline. Also, lights mounted on the exterior of the boat often require replacement and repair from outside the boat rather than from the inside of the boat which is usually fairly cumbersome.

In order to better project the light onto the surface of the water from a light source placed above the waterline, the lights have been extended outward such that they are spaced away from the hull surface. For example, U.S. Pat. No. 5,355,149 discloses a utility light apparatus that is mounted on a gunwale of a boat by applying the light to the distal end of a conventional fishing rod holder such that the light extends out over the side of the boat in an arm-like fashion. Therefore, the extended light pathway illuminates more of the water's surface and is less likely to be obstructed by other appurtenances placed on the side of the boat. However, unless the height of the boat is relatively shallow, the depth to which the light penetrates the water is still very limited by the light intensity as the light source is placed well above the waterline at the gunwale of the boat. Thus, the conventional hull or deck mounted lights do not provide sufficient lighting for visualizing harmful objects within the path of the watercraft or exploring the water around and below the watercraft. Furthermore, lights extending outward from the surface of the boat are easily damaged in comparison to lights which are integrated into the surface area of the boat such that they are only slightly protruding or not protruding at all.

More recently, lights have been integrated into the hull surface area of a watercraft by placing them into thru-hull fittings of the hull thereby providing a watertight lighting apparatus which may be positioned below the waterline in order to provide a significantly improved visualization of the surrounding water area and to enhance the aesthetics of the boat. Also, by placing the light assembly inside a thru-hull, replacement or repair can be done from the inside of the boat where access is normally much simpler than outside the boat. Typically, a light bulb or lamp supporting means is placed inside the thru-hull from inside the boat and a secured lens is placed between the lamp and the exterior opening of the thru-hull such that the light passes through the lens and into the water. The light bulb supporting means is surrounded by a housing that is either cylindrical for secure fit against the sides of the thru-hull or is a conical, tapered piece which narrows towards the interior of the boat. A flange placed flush against the outside surface of the thru-hull and one or a series of o-rings or watertight sealants or adhesives are used to provide a watertight seal between the lens and the exterior opening of the thru-hull. The exterior flange is usually cast as one piece with a housing which penetrates the hull. The single casting then requires considerable machining to allow for placement of lenses and accessories which make use of the view port. Alternative constructs include manufacture of the housing and flange in two pieces which are then welded together. Welded configurations have the drawback in that if identical materials are not used, welding is difficult and the integrity of the weld may be suspect when used in an underwater environment where failure could be catastrophic.

The flange may be formed with the light housing as one piece or may be separate from the housing such that it is removably attached to the side of the hull by screws that are screwed into holes bored into the hull surface.

Also, it is desirable to form the light housing and flange of two different types of metals in order to obtain the highest heat dissipating light housing on the interior of the hull and the most anti-corrosive flange on the exterior of the hull where the assembly comes into contact with the water. A one-piece configuration limits the entire assembly to one type of metal. Even where the flange and light housing are welded together, there are many metals which cannot be welded tightly to one another. Where the flange must be attached to the hull by screws, several screw-holes must be bored into the hull thereby damaging the hull surface and providing additional inlets where water moisture may create damage. Where the flange is snapped into place, it is difficult to obtain a substantially watertight seal between the flange, lens and the exterior opening of the thru-hull.

All thru-hull lighting known in the art utilizes lenses made from transparent materials. In fact, U.S. Pat. No. 7,044,623 uses highly transparent flat sapphire glass lenses for the purpose of increasing the efficiency of light transmission. One downside to using such lenses is that the light shines out from the hull in a thin, pencil beam fashion thus necessitating the use of a large number of lights spaced close together when lighting large areas of the hull is desired. The costs of installation greatly increase due to the need to buy additional lights.

The pencil beam problem is even more pronounced with LED lights which are a true point source of light. Efforts to reduce the pencil beam effect have centered around using collimators such as are set forth in published United States patent application number 2007-0139913 A1 to Savage. Even with the use of collimators as taught by Savage, LED lights still generally produce defined beams unless clustered extremely close together. When clustered together in a fixture with multiple collimators, the lights do not provide uniform dispersed lighting but still produce a defined beam with varying intensity across the light field. As a result a larger number of lights is required to light a given area. If collimators are eliminated from known LED lights, the light field does not adequately penetrate the water requiring the use of a greater number of LEDs or higher power LED lights to provide the desired field of illumination. Additionally, where bulb wattages of each lamp commonly range from 35 to 150 watts, installing large numbers of lights on a vessel can overload an inadequately designed electrical system. Upgrading an electrical system to handle the load can significantly add to the cost of installation. Where a vessel must carry its electrical source onboard while away from the dock, the need for an ample battery storage or power generating capability for all anticipated uses creates a large practical burden as space is a premium on all vessels, particularly on smaller fiberglass boats. Similarly, there is a practical limit to the weight that can be carried. The smaller the boat, the more it is affected by the weight of a heavy battery. Furthermore, large battery banks require considerable maintenance and can present significant safety concerns if a connection shorts or the batteries are overcharged and vent hydrogen and gaseous sulfuric acid.

The presence of an adequately sized generator can reduce or eliminate the need for storage batteries. However, generators have their own drawbacks. Fuel, a commodity which is becoming increasingly more expensive and scarce in remote areas, is needed in order to operate a generator. Also, generators have inherent safety risks and require maintenance for their safe and efficient operation.

Where underwater lights must be of high intensity in order to be useful, the use of a large number of lights produces a significant amount of heat and dispersing that heat becomes an increasingly difficult problem. High intensity lights installed adjacent to the cabin of the boat will heat the air in the cabin. When in an air-conditioned space, this increases the cooling load and requires additional electrical power to remove the heat. Particularly on smaller boats, when in a non-climate controlled space, the heat can make an enclosed space uncomfortably warm for the occupants.

It is an object of this invention to reduce the number of lights required for illuminating the area immediately around the hull of a vessel.

It is an object of this invention to reduce the amount of energy required to light the area around the hull of a vessel thereby conserving natural resources.

It is an object of this invention to reduce the amount of heat released by high intensity underwater lights into the interior of a vessel.

It is an object of this invention to provide an underwater light in which the light assembly contains a means for diffusing the light around the sides of the vessel, thereby reducing the number of lights required for illumination.

### BRIEF DESCRIPTION OF THE DRAWINGS

FIG. 1 is a cross-sectional view of a first preferred embodiment of the present invention in a fully assembled configuration.

FIG. 1A is a perspective view of the embodiment of FIG. 1 in a fully assembled configuration.

FIG. 2 is a cross-sectional view of a second preferred embodiment of the present invention in a fully assembled configuration.

FIG. 2A is a perspective view of the embodiment of FIG. 2 in a fully assembled configuration.

FIG. 3A is a side view of an illumination cone resulting from the underwater light of the present invention using a three LED array wherein only one LED is emitting light.

FIG. 3B is a top view of an illumination cone resulting from the underwater light of the present invention using a three LED array wherein only one LED is emitting light.

FIG. 3C is a perspective view of an illumination cone resulting from the underwater light of the present invention using a three LED array wherein only one LED is emitting light.

FIG. 4A is a side view of an illumination cone resulting from the underwater light of the present invention using a three LED array wherein only two of the LEDs are emitting light.

FIG. 4B is a top view of an illumination cone resulting from the underwater light of the present invention using a three LED array wherein only two of the LEDs are emitting light.

FIG. 4C is a perspective view of an illumination cone resulting from the underwater light of the present invention using a three LED array wherein only two of the LEDs are emitting light.

FIG. 5A is a side view of an illumination cone resulting from the underwater light of the present invention using a three LED array wherein all three of the LEDs are emitting light.

FIG. 5B is a top view of an illumination cone resulting from the underwater light of the present invention using a three LED array wherein all three of the LEDs are emitting light.

FIG. 5C is a perspective view of an illumination cone resulting from the underwater light of the present invention using a three LED array wherein all three of the LEDs are emitting light.

FIG. 6 is a view of the full illumination cone of FIGS. 5A through 5C as it would appear if the underwater light of the present invention were directed at a flat surface.

FIG. 7 is a side view of the domed or convex lens of the present invention.

FIG. 8 is a side view of the plano convex lens.

FIG. 9 is a front view of the plano convex lens.

FIG. 10 is cross section of the plano convex lens.

FIG. 11 is a perspective view of the front of the plano convex lens.

FIG. 12 is a perspective view of the back of the plano convex lens.

FIG. 13 is a front view of the LED light.

FIG. 14 is a back view of the LED light.

FIG. 15 is a view of an embodiment of the present invention mounted on a trim tab.

### DETAILED DESCRIPTION OF THE INVENTION

For a better understanding of the present invention, reference may be had to the following detailed description taken in conjunction with the appended claims and the accompanying drawings.

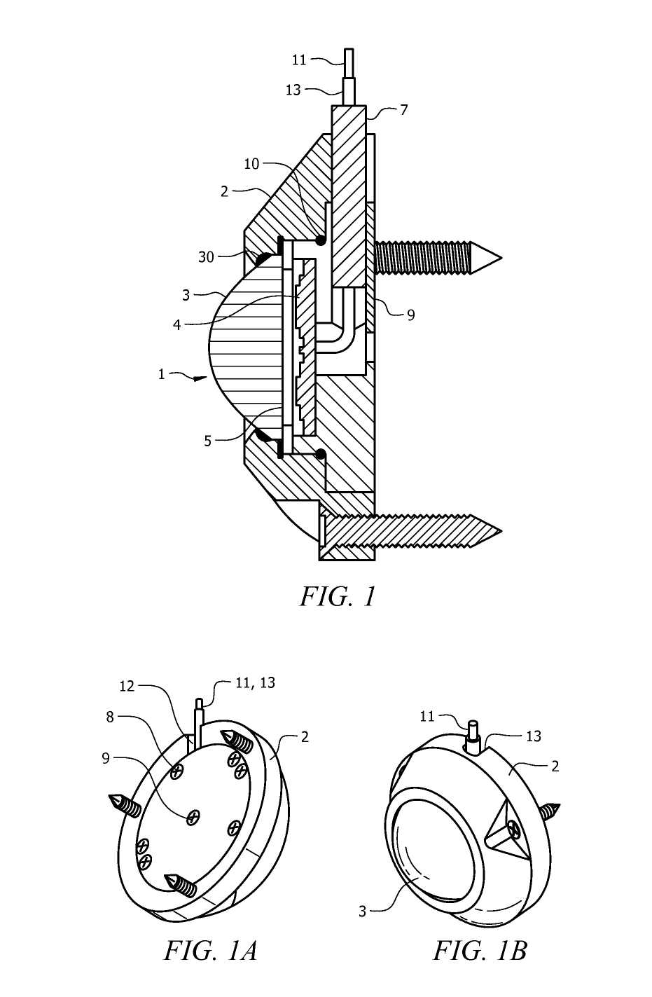

The present invention is an underwater light assembly that can either be surface-mounted to a surface of the vessel or can form a thru-hull view port assembly that is constructed to have a watertight fit in the hull or deck of a vessel. Unlike conventional lights, the present invention utilizes optical lenses to simultaneously disperse and focus the light. FIG. 1 depicts a first preferred embodiment of the present invention wherein the underwater light assembly 1 is configured to be surface-mounted to the surface of a vessel. Main body 2, having an inner and outer face, is used to mount the assembly 1 to an exterior surface of the vessel. A substantially transparent lens 3 is removably mounted on the inner surface of the main body 2.

Preferably, lens 3 is of a suitable shape for diffusing the light from light source 4 and is preferably composed of a heat and pressure resistant material such as borosilicate glass. As will be appreciated by one of skill in the art, any substantially transparent material that is resistant to high temperature and high pressure and is resistant to erosion and chemicals can be used. Suitable materials include chemically hardened or tempered and impact resistant materials such as quartz glass, tempered (Pyrex), borosilicate, or sapphire crystal may also be used as can plastic materials having suitable optical properties. The lens is retained in place by a glass retaining ring 5 and the main body 2. The hollow interior of the main body 2 is tapered such that the proximal end is of narrower diameter than the distal end. The diameter of the glass retaining ring 5 is equal to the diameter of the wider, distal end of the main body 2 such that a retaining groove 30 is formed for capturing the lens 3 between the main body 2 and the glass retaining ring 5.

The glass retaining ring 5 is compressed against the back of the lens 3 by a back cover 7 that is screwed onto the distal end of the main body 2 by one or more screws 8 (shown in detail in FIG. 1A). The diameter of the back cover 7 is equal to the diameter of the distal portion of the interior of the main body 2 such that the back cover 7 fits into the interior of the main body 2 leaving an entirely flat back surface 9 that may be easily mounted to the exterior of a vessel. The back cover 7 may be made out of any suitable metal (e.g. aluminum, stainless steel or bronze) or polymer material although marine grades of aluminum are most preferred due to their corrosion resistance and strength when used inside the vessel and their ability to rapidly dissipate heat compared to other materials having suitable mechanical properties. A watertight seal may be formed between the back cover 7 and the main body 2 by a polymer gasket or o-ring 10. The gasket or o-ring 10 is preferably comprised of a compressed Buna-N sheet gasket material. Other suitable sealing means such as silicone, polyether, polyurethane or other sealants acceptable for use below the waterline may also be used for forming the watertight seal between the back cover 7 and the main body 2.

The light source 4 is preferably an array of one or more light emitting diodes (LEDs) that may be white and/or various colors (e.g. red, blue, green). The LED array 4 is mounted on a control board and the entire LED module is thereafter installed within the underwater light assembly 1 and is preferably placed between the glass retaining ring 5 and the back cover 7 such that light emitted from the LEDs exits through the lens 3 and into the surrounding water. Power is provided to the LED module by an electrical cable 11 that includes a strain relief 13. A groove 12 may be formed in the main body 2 such that the electrical cable 11 can access the module without creating an obstacle for mounting the assembly to the exterior surface of a vessel. The electrical cable 11 can be sealed into the back cover 7 using a small amount of encasing epoxy or electrical potting material.

LEDs are preferably used for this application because they are highly efficient in comparison to other types of light sources, such as high-intensity discharge lamps, fluorescent or iridescent lamps, etc. LEDs provide a high intensity light without requiring a lot of power and energy to produce the light. Therefore, the number of lights needed to provide the desired amount of light is greatly reduced and energy resources are dramatically conserved. Depending on the type of lighting effect that is desired for a particular vessel or application, different colored LEDs may be used to create a wide range of aesthetic affects. However, LEDs are generally point sources of light and can only emit focused, narrow beams of light compared to other types of light sources and therefore, the light emitted from the LEDs does not have the same range of illumination as the other light sources. Furthermore, where one or more LEDs are used, the emitted light from each of these LEDs do not easily blend to form one homogeneous light field to create a uniform illumination effect. Thus, it is desirable to be able to diffuse the emitted light from an LED using the lens 3 into the surrounding water in order to create a highly visible illumination effect. In addition, LEDs rarely need to be replaced in comparison to most other types of light sources.

Most LED lights are used in connection with a collimator which is mounted in connection with each individual LED. Such arrangements are known in the art and are typified by those show in published patent application 2007-0139913 A1 to Savage. The problem with such arrangements is that each LED/collimator combination produces a discrete visible light beam with a clearly visible pencil beam surrounded by a more diffuse region. In order to create a uniform field of light using conventional LEDs with collimators a very large number of closely spaced lights must be used. The present invention avoids this need by using a magnifying and diffusing lens which avoids the pencil beam effect thereby allowing the lights to spread further apart.

The diffusing lens is selected so that it diffracts the light coming from each source LED but yet still focuses the resulting light to reduce diffraction outside of the desired light field. This allows for maximum penetration into the water. An ideal lens will maximizes the light field in a planar direction away from the vessel which is roughly parallel to the water's surface yet also projects to the sides of the light such that the resultant light from the fixture appears as a single light non-point light source focused by a reflector. The goal of such a light is to provide a beam of light without the pencil beam effect inherent in using a single point source of light either with or without a collimator.

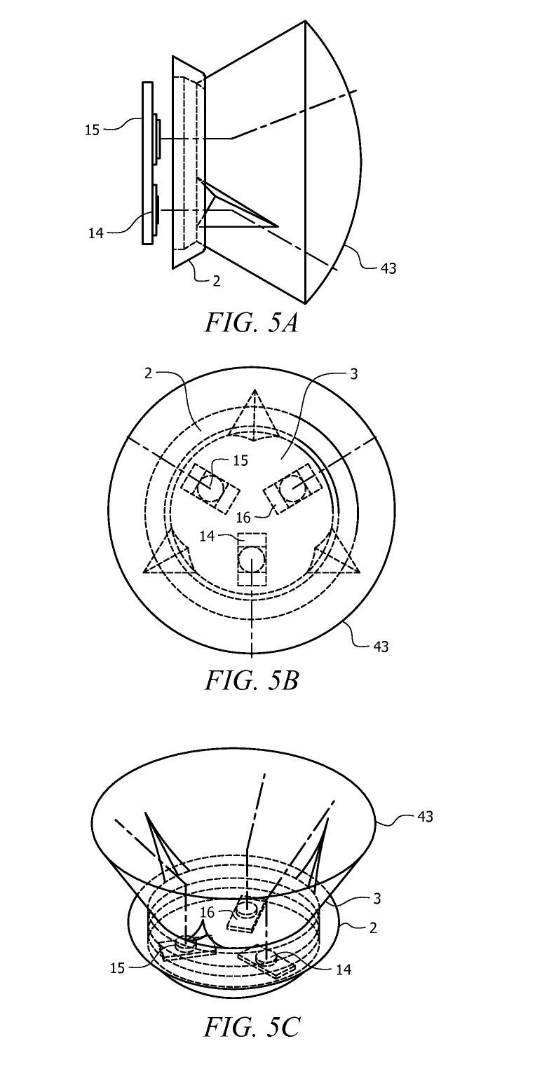

The diffusing lens 3 used in the present invention may be comprised of a prismatic material or may be any other shape of lens which does not focus the individual LED lights into a plurality of beams. While any diverging lenses which are thicker at the edges than in the center can also be used. Diverging lenses can be bioconcave (having two concave faces), plano-concave (having a plane face and a concave face), or concavo-convex or a diverging meniscus (having a convex face and a concave face with a smaller radius of curvature). Fresnel lenses can also be made to be diverging lenses. In one embodiment, as shown in FIG. 1, and in detail in FIG. 7, the lens 3 is preferably formed into a smooth convex surface or dome. The domed or convex optically transparent lens 3 increases and directs the illumination pattern of the LED array 4 beyond that of the light source proper and blends multiple and spaced apart light sources or LEDs into a uniform and homogenous illumination pattern. Ideally, the lens 3 will broadcast or diverge the light through a 180° degree included angle “illumination cone” 21. The possible range of illumination 21 is constrained at its outer limits by the interior circumference 22 of the main body 2 as can be seen in FIG. 5C described below. The angle of the illumination cone can also be varied by placing the light source 4 closer or farther away from the inside flat surface 50 of the domed lens 3. In another alternative embodiment, the light source or LEDs may be placed in the center of an enclosed transparent glass ball wherein the light would project at an approximate 360° degree included angle.

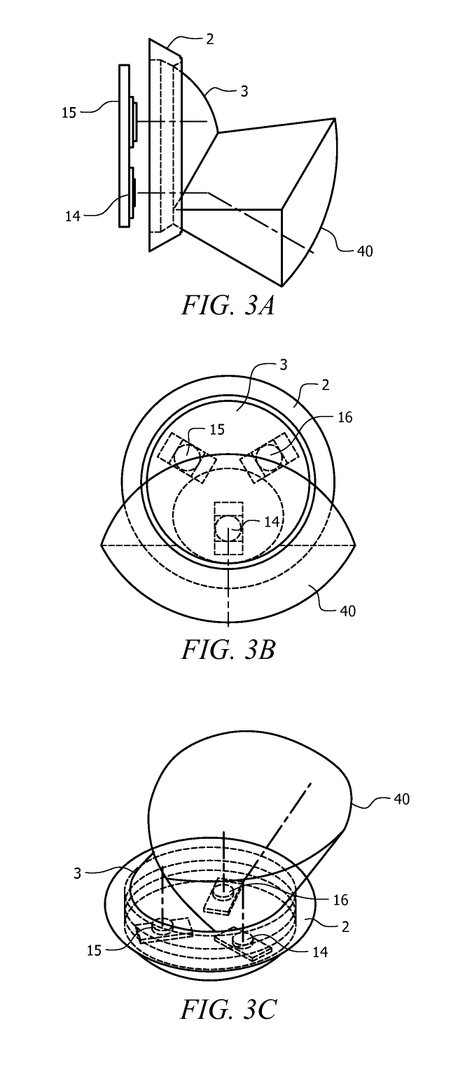

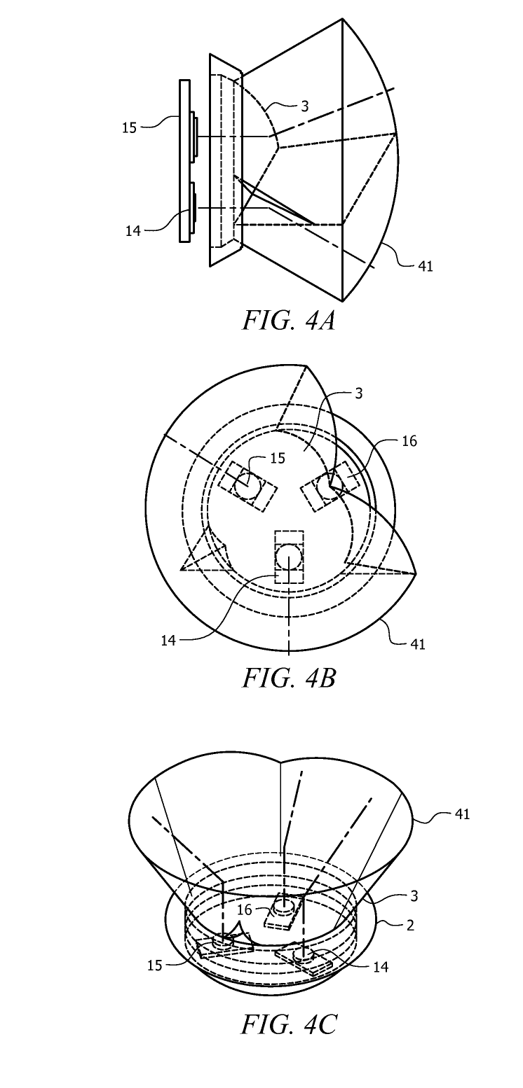

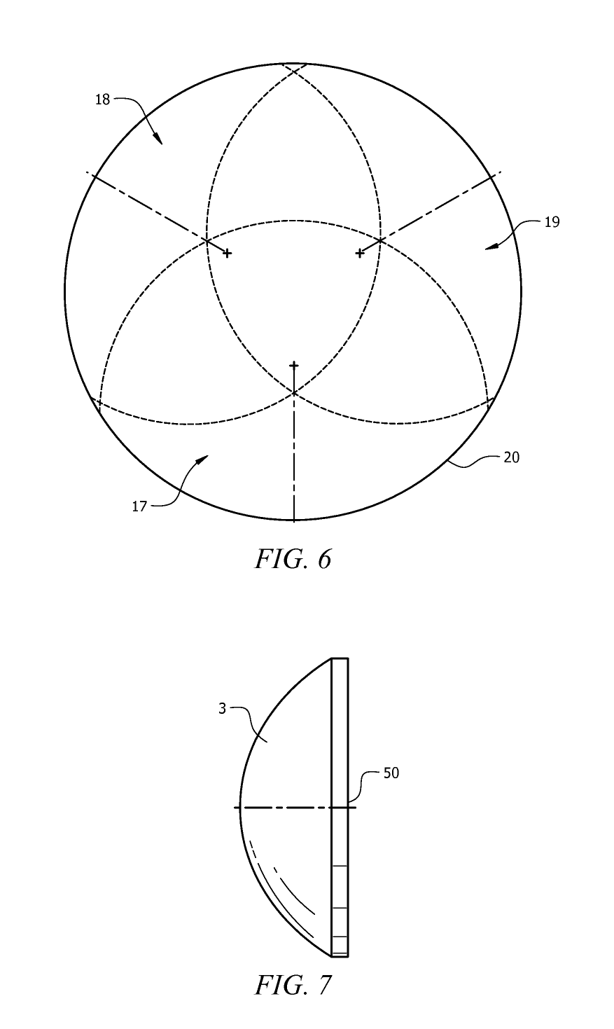

FIGS. 3A-3C, 4A-4C and 5A-5C depict how the lens 3 can produce three different illumination patterns using an LED array having 3 LEDs 14, 15 and 16. The 3 LEDs emit three resulting illumination areas 17, 18 and 19, which are depicted in FIG. 6 as they would appear if the assembly 1 were directed at a flat surface. The three illumination areas combine to form one uniform and homogenous illumination pattern 20 despite that the light source is comprised of three spaced apart LEDs. FIGS. 3A through 3C depict the resulting illumination cone 40 only a single LED 14 is emitting light. Although only a single LED is emitting light, the resulting illumination has a much larger diameter than it would have with just a simple, flat clear film or lens placed across the LED or with a lens that was not shaped to diffuse the light. FIGS. 4A through 4C depict the resulting illumination cone 41 when two LEDs 14 and 15 are emitting light. FIGS. 5A through 5C depict the resulting illumination cone 43 when all three LEDs 14, 15 and 16 are emitting light. Thus, by using the lens 3 and by controlling which LEDs of an LED array are emitting light, different angles of illumination can be created where desired without the use of reflectors. The embodiment of FIGS. 3A-3C, 4A-4C and 5A-5C depict how the interior circumference 22 of the main body 2 constrains the illumination cone 21. Although the lens 3 is capable of distributing a 180° degree included angle illumination cone 21, the net light opening of the main body 2 results in an approximate 60° degree included angle illumination cone 21.

In order to secure the assembly 1 to the exterior surface of a vessel, the main body 2 includes one or more threaded screw holes 14 wherein screws 15 are threaded from the proximate to the distal end of the main body 2 and into one or more corresponding bored screw holes in the exterior surface of the vessel such that the assembly 1 is brought into tight contact with the exterior surface of the vessel. A thin film of a suitable sealant may be applied to the contact surfaces of the main body 2 and the back cover 7.

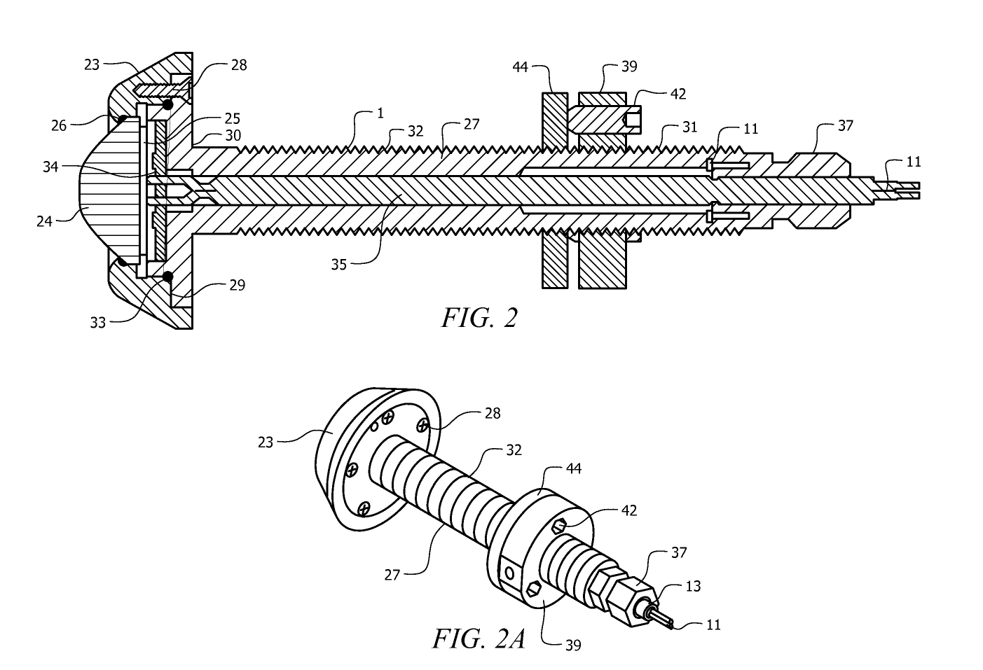

FIG. 2 depicts a second preferred embodiment of the present invention wherein the underwater light assembly 1 is configured to have a watertight fit in the hull or deck of a vessel. The light assembly 1 is comprised of a flange 23 having an interior and exterior face that is used to mount the assembly 1 to the exterior of the vessel. The substantially transparent lens 24, preferably shaped to be a diffusing lens, having a top and a bottom surface is removably mounted on the inner surface of the flange 23. The lens 24 is retained in place by a glass retaining ring 25 and the flange 23. The hollow interior of the flange 23 is tapered such that the proximal end is of narrower diameter than the distal end. The diameter of the glass retaining ring 25 is equal to the diameter of the wider, distal end of the flange 23 such that a retaining groove 30 is formed for capturing the lens 24 between the flange 23 and the glass retaining ring 25. Polymer glass gaskets or o-rings 26 may be placed on either side of the lens in order to form a watertight seal between the flange 23 and the lens 24. The gaskets or o-rings 26 are preferably comprised of a compressed Buna-N sheet gasket material.

The glass retaining ring 25 is compressed against the back of the lens 24 by a main body 27 of the assembly 1 that is screwed onto the distal end of the flange 23 by one or more screws 28. As shown in FIG. 2, the main body 27 is comprised of a proximate end 29 having a flat surface 30 and a distal end 31 having an elongated cylindrical shape with external threads 32. The diameter of the proximate end 29 of the main body 27 is equal to the diameter of the distal portion of the interior of the flange 23 such that the main body 27 fits into the interior of the flange 23. The main body 27 may be made out of any suitable metal (e.g. aluminum, stainless steel or bronze) or polymer material although marine grades of aluminum are most preferred due to their corrosion resistance and strength when used inside the vessel and their ability to rapidly dissipate heat compared to other materials having suitable mechanical properties. A watertight seal may be formed between the flange 23 and the main body 27 by a polymer gasket or o-ring 33. The gasket or o-ring 33 is preferably comprised of a compressed Buna-N sheet gasket material. Other suitable sealing means such as silicone, polyether, polyurethane or other sealants acceptable for use below the waterline may also be used for forming the watertight seal between flange 23 and the main body 27.

The light source 34 is preferably an array of one or more light emitting diodes (LEDs) that may be white and/or various colors (e.g. red, blue, green). The LED array 34 is mounted on a control board and the entire LED module is thereafter installed within the underwater light assembly 1 and is preferably placed between the glass retaining ring 25 and the main body 27 such that light emitted from the LEDs exits through the lens 24 and into the surrounding water. Power is provided to the LED module by an electrical cable 11 that is directed through the hollow interior 35 of the main body 27.

While primary water resistance is provided by the flange 23 and the gaskets or o-rings 26 and 33, secondary water resistance can be provided by use of a cap 36 that is inserted into the hollow interior 35 at the distal end 31 of the main body 27. The cap preferably includes a cable strain relief 37 for coupling to a cable that originates from inside the boat and provides power to and/or a signal from the light source or other device mounted inside the assembly 1. The cap may be made out of any suitable metal or polymer material although marine grades of aluminum are most preferred due to their corrosion resistance and strength when used inside the vessel and their ability to rapidly dissipate heat compared to other materials having suitable mechanical properties. A gasket or o-ring 38 may be used to maintain a watertight seal between the cap 36 and the main body 27.

In order to secure the assembly 1 of FIG. 2 to the inside of a vessel hull, a locking ring 39 having internal threads 40 which are sized to screw down on the external threads 32 of the main body 27. Locking ring 39 pulls flange 23 into position against the outside of the vessel hull. Optionally, in order to adapt the entire lighting assembly 1 to slight angular variations in hull shapes, a compression ring 41 in combination with locking ring 39 is provided along the exterior mid-portion of main body 27. Although the flange 23 must stay flush against the side of the boat at the hull opening, the compression ring and locking ring may be adjusted such that the main body of the assembly may tilt slightly in order to accommodate angle variations in the hull. The compression ring is preferably composed of aluminum and has a smooth interior and exterior surface. The compression ring surrounds the exterior of the mid-portion of the main body and acts as a washer separating the main body from the walls of the hull. The corners of the compression ring are beveled so as to provide smooth contact with the walls of the hull. At the distal side of the compression ring, locking ring 39 is screwed onto the mid-portion of the main body via its threaded interior surface. The locking ring is also preferably composed of aluminum. Along the circumference of the locking ring are two or more set screws 42 whose bodies extend past the locking ring and abut the distal side of the compression ring. Thus, in order to vary the angle at which the compression ring aligns the assembly with the walls of the hull, each of screws 42 may be individually threaded in the bores of the locking ring at different heights so as to change the angle of the abutting compression ring.

Alternatively, the flange 23 can be directly welded to the vessel hull. When welded, there is no need to bed the flange to the hull to reduce leaks and the internal locking and compression rings can be eliminated.

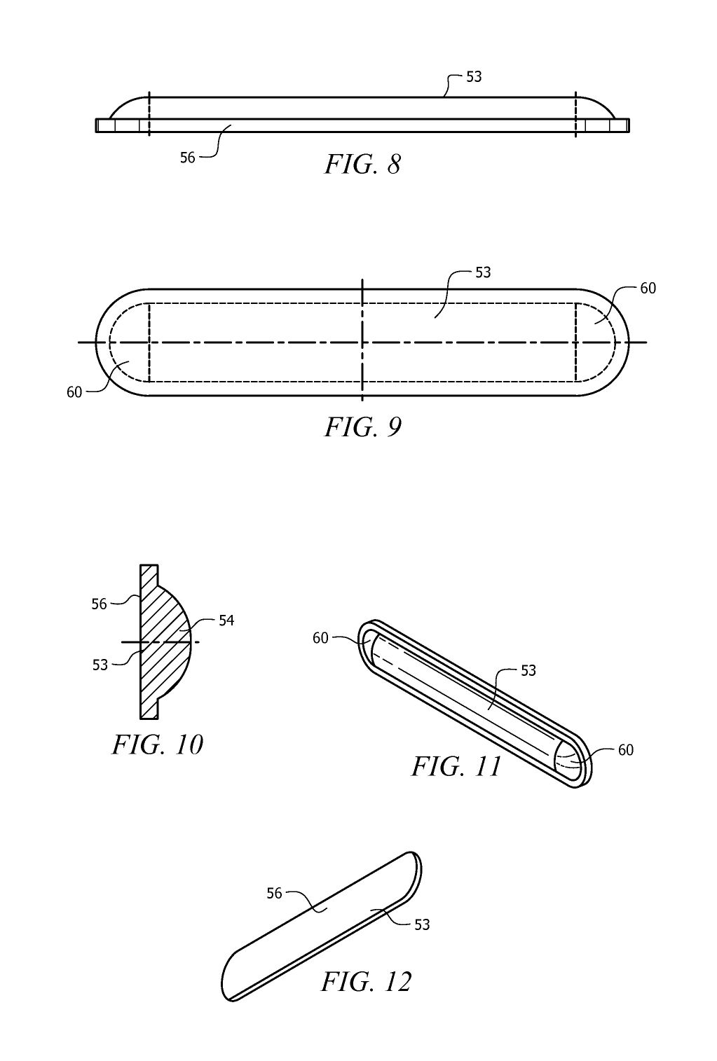

FIGS. 8-14 depict another preferred embodiment comprising a plano convex lens 53 having convex ends 60. A plano convex lens has one side which is convex 54 and the other side is substantially planar 56. Most preferred is a cylindrical plano convex lens. This embodiment is similar to the domed lens discussed above but the more linear nature of the lens allows it to more readily accommodate a more linear arrangement of LEDs in a light. This allows fewer lights to be used to create a desired horizontal light field.

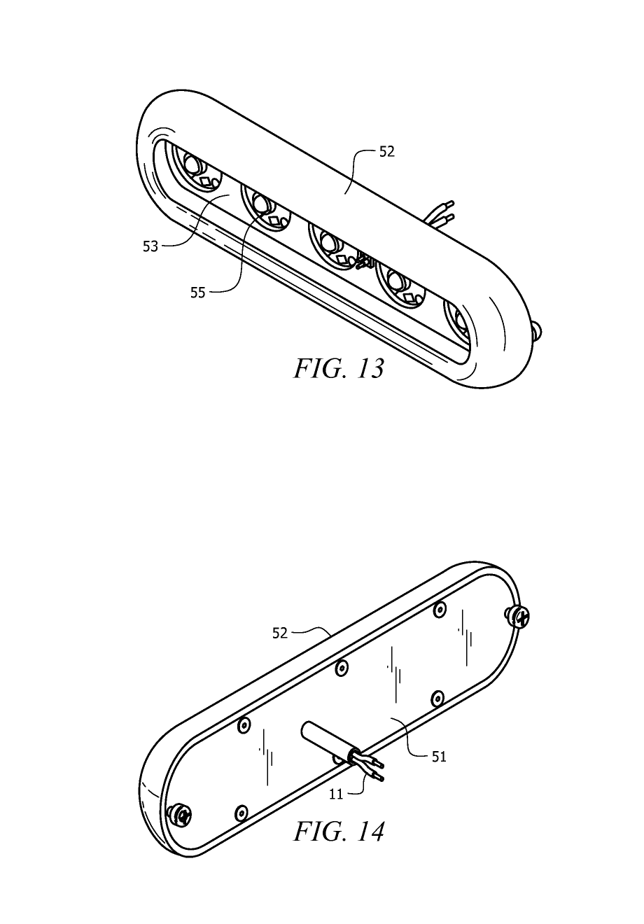

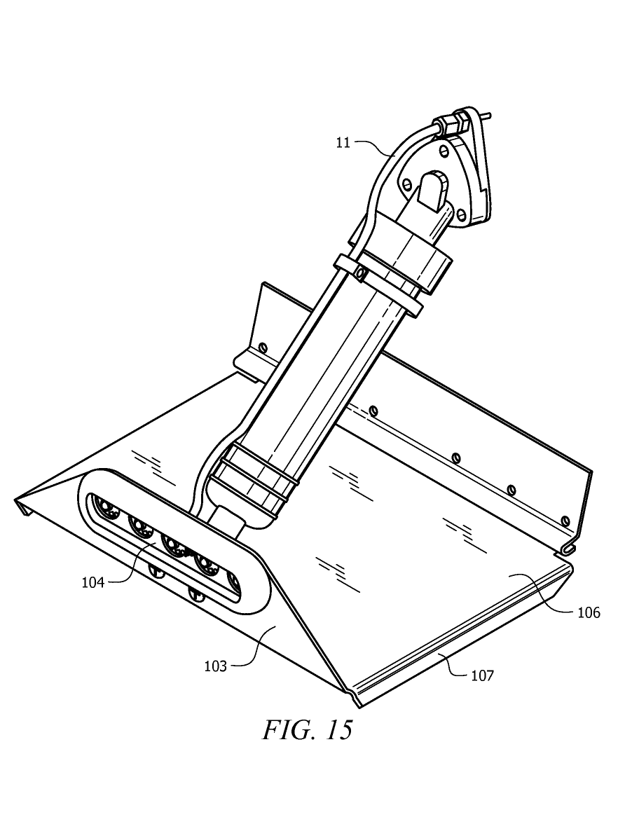

FIGS. 13 and 14 show an alternative linear light design using the plano convex lens 53. In this embodiment The LED array 55 is preferably substantially linear and mounted on the backing plate 51. A front flange 52 holds the lens 53 in a watertight fashion, preferably using an o-ring. In the preferred embodiment the front flange 52 is further sealed against the back cover using an o-ring. The front flange 52 and backing plate 51 may be secured by any suitable means capable of maintaining the mechanical relationship of the parts. Most preferable is a plurality of screws threaded through the back of the back cover into the front cover and spaced to spread the compression forces around the o rings. The use of screw allows the replacement of parts if necessary. The housing can also be bonded using suitable glues or adhesives.

Referring to FIGS. 8-12, the lens 53 can be made from any suitable material but is preferably molded from polycarbonate. The lens diffracts the light from each LED and directs it outward through the front of the lens. The front of the lens is shaped to be received within the front flange. FIGS. 8-12 further show the plano convex lens 53 having a substantially flat surface 61 on the back side of the lens and a convex surface 62 on the front side. The lens also preferable includes at least one surface suitable for forming a watertight seal with the cover. In the most preferred embodiment the seal is an o-ring but may be any suitable means for forming a water tight seal between the lens and the cover.

The light cast by the light described in the second embodiment when mounted horizontally on the side of a vessel, will project outward as a diffuse horizontal beam with reduced or no visible pencil beams projecting from individual LED's. Suitable plano convex lenses without convex ends are sold by Melles Griot such as catalog number 01LCP 002.

In another preferred embodiment, the lens is molded from a polyphenylene sulfide, a thermally conductive plastic, such as is sold under the trademark CoolPoly® E5101 by Cool Polymers Inc. As LED lights increase in intensity, the amount of heat emitted by the LEDs increases. The use of lenses manufactured from a polymer with good heat conducting properties will facilitate the transmission of heat into the surrounding environment.

Optionally, and as depicted in the embodiments of FIGS. 1 and 2, the underwater light assembly 1 can be comprised of two pieces in which the external portion (e.g. the main body 2 or flange 23 in FIGS. 1 and 2 respectively) and the internal housing (e.g. the back cover 7 or main body 27 in FIGS. 1 and 2 respectively) can be manufactured from the most preferred materials for the environment and/or application. The present invention requires the use of metals having sufficient structural strength and corrosion resistance to comprise the components of the assembly exposed to the water in order to maintain a water tight seal below the waterline. Materials used inside the hull must have sufficient mechanical strength for secure fastening to the flange and should have appropriate heat transfer properties to minimize heat buildup in the view port. TABLE 1 is a list of the galvanic potential of various common metals starting with magnesium which is the most reactive and ending with platinum which is the least reactive.

TABLE 1
Galvanic Properties

| Most Reactive | Least Reactive |
|---|---|
| MAGNESIUM | COPPER (CA102) |
| MAGNESIUM ALLOYS | MANGANESE BRONZE (CA 675), TIN |
| | BRONZE (CA903, 905) |
| ZINC | SILICON BRONZE |
| ALUMINUM 5052, 3004, 3003, 1100, 6053 | NICKEL SILVER |
| CADMIUM | COPPER-NICKEL ALLOY 90-10 |
| ALUMINUM 2117, 2017, 2024 | COPPER-NICKEL ALLOY 80-20 |
| MILD STEEL (1018), WROUGHT IRON | 430 STAINLESS STEEL |
| CAST IRON, LOW ALLOY HIGH | NICKEL, ALUMINUM, BRONZE (CA 630, |
| STRENGTH STEEL | 632) |
| CHROME IRON (ACTIVE) | MONEL 400, K500 |
| STAINLESS STEEL, 430 SERIES (ACTIVE) | SILVER SOLDER |
| 302, 303, 304, 321, 347, 410, 416, STAINLESS | NICKEL (PASSIVE) |
| STEEL (ACTIVE) | |
| NI-RESIST | 60 NI-15 CR (PASSIVE) |
| 316, 317, STAINLESS STEEL (ACTIVE) | INCONEL 600 (PASSIVE) |
| CARPENTER 20 CB-3 STAINLESS | 80 NI-20 CR (PASSIVE) |
| (ACTIVE) | |
| ALUMINUM BRONZE (CA 687) | CHROME IRON (PASSIVE) |
| HASTELLOY C (ACTIVE) INCONEL 625 | 302, 303, 304, 321, 347, STAINLESS |
| (ACTIVE) TITANIUM (ACTIVE) | STEEL (PASSIVE) |
| LEAD-TIN SOLDERS | 316, 317, STAINLESS STEEL (PASSIVE) |
| LEAD | CARPENTER 20 CB-3 STAINLESS |
| | (PASSIVE), INCOLOY 825 |
| TIN | NICKEL-MOLYBDEUM-CHROMIUM- |
| | IRON ALLOY (PASSIVE) |
| INCONEL 600 (ACTIVE) | SILVER |
| NICKEL (ACTIVE) | TITANIUM (PASS.) HASTELLOY C & |
| | C276 (PASSIVE), INCONEL 625(PASS.) |
| 60 NI-15 CR (ACTIVE) | GRAPHITE |
| 80 NI-20 CR (ACTIVE) | ZIRCONIUM |
| HASTELLOY B (ACTIVE) | GOLD |
| BRASSES | PLATINUM |

It is preferred to use materials from the least reactive materials in TABLE 1 that have the appropriate mechanical properties for the application. Standard marine fittings are generally made of bronze or 316 or 317 stainless steel for both their strength and corrosion resistance when used below the waterline. While these materials offer excellent corrosion resistance, they do not dissipate heat well. As such, they are less preferred for use in applications where heat may be generated such as in a light or camera housing. When the assembly will hold a heat emitting device, it is preferred that the body of the assembly be made from materials capable of rapidly dispersing the heat such as aluminum or copper. Most grades of aluminum however create a galvanic cell and corrode rapidly when immersed in an aqueous environment in the presence of any other metals. Furthermore, saltwater is an excellent electrolyte and fosters the creation of galvanic currents. As such, aluminum is a poor choice for any external use on any vessel hull and in no instance should aluminum be directly welded or affixed to steel hull vessels. In the marine environment, other metals are always present in the form of standard bronze through hull plumbing fittings, bronze and stainless propellers, rudder hardware, etc. While plastics do not corrode and have been used in thru-hull devices, they lack sufficient strength and durability for use in below the waterline applications. They are also cosmetically unappealing in comparison to highly polished metals.

The present invention allows for the use of corrosion resistant materials on the wet outside of the vessel hull and the use of heat dissipating materials on the dry inside of the vessel hull. For example, in FIG. 2, the flange 23 can be made of a corrosion resistant metal such as bronze, stainless steel, or titanium. The main body 27 is preferably made of a strong heat dissipating metal such as aluminum, titanium or brass or alloys thereof.

Another advantage in the assembly 1 being comprised of two pieces is the ability to repair the assembly from the inside of the hull, rather than having to remove the entire assembly from the exterior side of the vessel. The back cover 7 or main body 27 can be accessed from inside the hull and unscrewed at screws 8 or 28, respectively, such that the back cover or main body may be removed in the distal direction. The main body 2 or flange 23 remains in the thru-hull thereby leaving a sealed viewing hole in place during repair.

The lights of the present design allow for mounting in locations in which ordinary incandescent lights could not be placed due to size limitations. In a preferred embodiment, 1-an LED light of the present invention mounted to a vessel stem in combination with the trim tabs as shown in FIG. 15. Referring to FIGS. 15, the preferred embodiment uses an upturned edge 103 of the normally horizontally planar trim tab 106 to provide a vertical surface for mounting a light 104. In a most preferred embodiment, the edges 107 of the trim tab 1 are also down turned to provide additional stiffness to the tab and increased efficiency by directing water down that would otherwise be directed outward from the tab.

Alternatively, a bracket can be attached to the trim tab for positioning the light instead of the upturned edge. The use of a bracket would allow for retrofitting existing installations. This design eliminates the need to place additional holes in the transom of a boat to mount underwater lights. Further, on small boats with narrow transom widths, mounting the lights on the trim tabs prevents the tabs from shadowing the lights.

The LED lights of the present invention are suitable for mounting in almost any location where a water resistant light is desired including but not limited to below the water line, as deck lights, on boat masts, in live wells, under railings, in ceilings, steps, ladders, swim platforms, engine brackets, outboard motors, stern drives, and/or on walls. The lights can be mounted with hidden fasteners such as when the lights are fastened from the rear as show in FIGS. 13-15 or by fastening the lights from the front as shown in FIGS. 1, 1A and 1B.

Lights of the present invention are also suitable for using in wet indoor locations such as aquariums and terrariums. The LED array and drivers can be programmed to deliver a desired spectrum of lighting to stimulate photosynthesis or simulate different water depths or time of day. In such installations the lights are usually installed underneath a canopy pointed directly towards the water or other surface to be illuminated. The use of lights of the present invention in an aquarium setting will allow the use of fewer lights to provide uniform illumination and also reduce the inherent heat gain which occurs as greater numbers of lights are used. The waterproof nature of the present invention means that lights can also be installed inside aquascaping to illuminate areas which could not previously be illuminated by an overhead light.

In the foregoing description, the present invention has been described with reference to specific exemplary embodiments thereof. It will be apparent to those skilled in the art that a person understanding this invention may conceive of changes or other embodiments or variations, which utilize the principles of this invention without departing from the broader spirit and scope of the invention. The use of alternative materials such as metals, sealants, polymers and transparent glasses and polymers is both contemplated and expected as improvements are made in the relevant art. The specification and drawings are, therefore, to be regarded in an illustrative rather than a restrictive sense. Accordingly, it is not intended that the invention be limited except as may be necessary in view of the appended claims.

We claim:

1. A light, comprising:
a housing for attachment to a vessel wherein the housing has an internal space and an external opening;
a diverging lens sized to cover the external opening and secured thereon;
a watertight seal between the diverging lens and the housing comprising a sealant, gasket, o-ring or other mechanical seal; and
a light source comprising at least one LED mounted in the internal space;
wherein the lens diffuses the light generated by the light source in a manner that reduces or eliminates the pencil beam effect.

2. The light of claim 1 wherein the diverging lens is a lens having a convex surface.

3. The light of claim 2 wherein the domed lens projects at least a 180° degree illumination angle.

4. The light of claim 1 wherein the lens is a plano convex lens.

5. The light of claim 1 wherein the diverging lens is a prismatic lens.

6. The light of claim 1 wherein the light source is an LED array.

7. The underwater light of claim 6 wherein the LED array is mounted onto a control board.

8. The light of claim 1 wherein either the housing or the lens are comprised of a heat dissipating material.

9. The light of claim 7 wherein the lens is made from polyphenylene sulfide.

10. An underwater light, comprising:
a housing for attachment to a vessel hull wherein the housing is comprised of a proximate portion that is removably attached to a distal portion;
an internal and external opening in the housing;
a diverging lens sized to cover the external opening and secured thereon;
a light source mounted inside the housing;
wherein the lens diverges the light generated by the light source;
a watertight seal between the diverging lens and the housing comprising a sealant, gasket, o-ring or other mechanical seal;
a watertight seal between the proximate and distal portions of the housing comprising a sealant, gasket, o-ring or other mechanical seal; and
a means for securing the housing to a vessel.

11. The underwater light of claim 10 wherein the diverging lens is a domed lens having a convex surface.

12. The underwater light of claim 10 wherein the domed lens projects at least a 180° degree illumination angle.

13. The underwater light of claim 10 wherein the diverging lens is a prismatic lens.

14. The underwater light of claim 10 wherein the light source is mounted inside the housing at a distance from the lens that is dependent on the desired illumination angle.

15. The underwater light of claim 10 wherein the light source is an LED array.

16. The underwater light of claim 15 wherein the LED array is mounted onto a control board.

17. The underwater light of claim 10 wherein the proximate portion of the housing is an external flange.

18. The underwater light of claim 10 wherein the distal portion of the housing is comprised of an elongated cylindrical portion having a threaded exterior surface.

19. The light of claim 10 wherein either the housing or the lens are comprised of a heat dissipating material.

20. The light of claim 19 wherein the lens is made from polyphenylene sulfide.
